(19) United States
(12) Patent Application Publication
(10) Pub. No.: US 2026/0268206 A1
(43) Pub. Date: Sep. 10, 2026

(54) ADAPTIVE MODIFICATION OF POLICY BEHAVIOR THROUGH ADAPTIVELY CHANGING PARAMETERIZED REWARD WEIGHT UNIVERSAL VALUE FUNCTION APPROXIMATORS

(71) Applicant: SONY GROUP CORPORATION, Tokyo (JP)

(72) Inventors: Alisa Devlic, Stockholm (SE); Alfredo Reichlin, Stockholm (SE); Kaushik Subramanian, Metzingen (DE); Peter Wurman, Acton, MA (US)

(21) Appl. No.: 19/071,277

(22) Filed: Mar. 5, 2025

(51) Int. Cl. G06N 20/00

(52) U.S. Cl. CPC G06N 20/00

(57) ABSTRACT

Artificial intelligence (AI) policies are developed for artificial agents for various domains, where the behavior of such AI agents can be changed during run time by the agent adaptively adjusting weights for select parameters. A single policy can be trained to handle the selection of parameters across a predetermined range for each component of an artificial intelligent agent within a domain. The agents can be trained across a number of weights within the desired range for each component. These weights determine how much of a reward portion for each component should be considered by the agent during training. Thus, a formulation can be realized for UVFA-like goals based on compositional reward functions parameterized by their components' weights. The agents may be configured to predict a future negative event, where the agent can adaptively adjust the components' weights, in runtime, in efforts to avoid the predicted future negative event.

### BACKGROUND OF THE INVENTION

### 1. Field of the Invention

Embodiments of the invention relate generally to systems and methods of reinforcement learning. More particularly, embodiments of the invention relate to methods and systems using universal value function approximators (UVFA)-like goals based on compositional reward functions parameterized by their components' weights, where the weights are adaptively changed upon prediction of an upcoming event of interest.

### 2. Description of Prior Art and Related Information

The following background information may present examples of specific aspects of the prior art (e.g., without limitation, approaches, facts, or common wisdom) that, while expected to be helpful to further educate the reader as to additional aspects of the prior art, is not to be construed as limiting the present invention, or any embodiments thereof, to anything stated or implied therein or inferred thereupon.

In the field of Reinforcement Learning (RL), value functions V^{π}(s) are used to model the expected future reward for an agent starting in a state s and following a policy π. These value functions serve a dual purpose: guiding action selection directly or refining the learning process of a distinct policy function, particularly within the actor-critic framework.

Universal value function approximators (UVFA), V^{π}(s, g), are an extension of value functions that are additionally conditioned on a goal g, i.e., they estimate the future rewards starting from state s with the reward function depending on the active goal g. This augmentation allows a UVFA-based agent to attain proficiency across diverse objectives and potentially generalize learning to novel, unencountered goals. Exemplary goals for UVFA include a discrete set of goal states (e.g., 2D goal positions in a grid world with the agent rewarded for reaching the active goal position); or abstract representations like vectorized forms of arbitrary pseudo-reward functions.

In UVFA, a user selects a scalar component weight for a particular parameter and such weight is randomly sampled during training of the agent. This can result in a need for lengthy training, where it may be difficult to select the best UVFA values. Further, should the selected scalar component weights result in a negative behavior, there is no way to adjust the weight during a training epoch.

In view of the foregoing, there is a need for improved formulation for UVFA-like goals based on compositional reward functions parameterized by their components' weights, where the weights are able to be adaptively changed upon prediction of an upcoming event of interest in efforts to avoid the event of interest.

### SUMMARY OF THE INVENTION

Aspects of the present invention provide an improved formulation for UVFA-like goals based on a weighted composition of parametric reward functions where the weights are able to be adaptively changed upon prediction of an upcoming event of interest in efforts to avoid the event of interest. This allows training a single agent that can be trained and that can play the game scenario in an improved manner, where the agent can predict a negative behavior and a component weighting can be adjusted in efforts to avoid such a future negative behavior.

Embodiments of the present invention provide a method and a non-transitory computer readable storage medium tangibly embodying a computer readable program code having computer readable instructions that, when executed, causes a computer device to carry out the method of operating an artificial intelligent agent based on a weighted composition of adaptively adjustable parametric reward functions, wherein the method comprises defining a reward function based on a state and an action as a linear combination of a plurality of parameterized reward functions and a weight for each parameter of the plurality of parameterized reward functions; sampling multiple dimensions of the weight and the parameter for each of the plurality of parameterized reward functions from either a continuous or a discrete distribution; training a single policy of the artificial intelligent agent over a continuous goal space including the plurality of parameterized reward functions represented by the continuous distribution of the weight and the parameter for each of the plurality of parameterized reward functions; and adaptively adjusting, during operation of the artificial intelligent agent, the weight for one or more selected parameters of the parameterized reward functions.

In some embodiments, the method further comprises predicting an occurrence of an event based on a Q-value determination during operation of the artificial intelligent agent.

In some embodiments, which may be combined with any of the above embodiments, the occurrence of the event is avoided by the adaptively adjusting of the weight.

In some embodiments, which may be combined with any of the above embodiments, the predicted occurrence is determined by detecting one or more of the following indicators: (1) a normalized derivative of a Q value being above a given threshold, (2) a normalized variance of the Q value above a given threshold, and (3) a derivative of the normalized variance having a local maxima.

In some embodiments, which may be combined with any of the above embodiments, a determination of two of the indicators prompts the artificial intelligent to adaptively adjust one or more weight to avoid occurrence of the predicted event.

In some embodiments, which may be combined with any of the above embodiments, the adaptively adjusted one or more weight is selected that provides a minimum norm of the derivative of the Q value (finite time difference) thereof.

In some embodiments, which may be combined with any of the above embodiments, the method further comprises improving a performance of the artificial intelligent agent over a segment of the continuous distribution of the weight by providing a skewed distribution of weight, wherein the training is performed over the skewed distribution of weight for one or more of the plurality of component reward functions.

In some embodiments, which may be combined with any of the above embodiments, the skewed distribution of weight is a log-uniform distribution. The approach to sample weights for training, however, does not necessarily have to be skewed, i.e., be a log-uniform distribution. The training approach can use any distribution that the experimenter thinks will work for the behavior to be learned. The adaptation during evaluation is independent of how the weights are sampled during training.

In some embodiments, which may be combined with any of the above embodiments, the method further comprises applying the continuous distribution of weights and parameters to both a policy and a value function of a soft actor critic model.

In some embodiments, which may be combined with any of the above embodiments, the method further comprises updating a neural network policy from π(s) to π(s, w*, θ*) and the action-value function Q(s, a) to Q(s, a, w*, θ*) by concatenating the continuous distribution of weights, w* and parameters θ* with inputs related to a state, s.

In some embodiments, which may be combined with any of the above embodiments, the method further comprises evaluating the single policy of the artificial intelligent agent at inference time by choosing a chosen weight and a chosen parameter for each of the plurality of parameterized reward functions, wherein the artificial intelligent agent behaves accordingly under a chosen reward function without any retraining.

In some embodiments, which may be combined with any of the above embodiments, the artificial intelligent agent operates in a racing game environment.

In some embodiments, which may be combined with any of the above embodiments, the event is an adverse event in the racing game environment.

In some embodiments, which may be combined with any of the above embodiments, each of the plurality of parameterized reward functions are defined within the single policy of the artificial intelligent agent.

Embodiments of the present invention provide a method for avoiding an adverse event by an artificial intelligent agent operating in a racing game comprising defining a reward function based on a state and an action as a linear combination of a plurality of parameterized reward functions and a weight for each parameter of the plurality of parameterized reward functions; sampling multiple dimensions of the weight and the parameter for each of the plurality of parameterized reward functions from either a continuous or a discrete distribution; training a single policy of the artificial intelligent agent over a continuous goal space including the plurality of parameterized reward functions represented by the continuous distribution of the weight and the parameter for each of the plurality of parameterized reward functions; predicting an occurrence of the adverse event based on a Q-value determination during operation of the artificial intelligent agent; and adaptively adjusting, during operation of the artificial intelligent agent, the weight for one or more selected parameters of the parameterized reward functions to avoid the occurrence of the adverse event.

These and other features, aspects and advantages of the present invention will become better understood with reference to the following drawings, description and claims.

### BRIEF DESCRIPTION OF THE DRAWINGS

Some embodiments of the present invention are illustrated as an example and are not limited by the figures of the accompanying drawings, in which like references may indicate similar elements.

FIG. 1 illustrates input modifications of the actor network of an exemplary soft actor-critic (SAC) algorithm to inform the agent on reward weights, according to an illustrative embodiment, using a subset of non-fixed dimensions of scalar component weights, w, and parameters, θ, as w* and θ*;

FIG. 2 illustrates input modifications of the critic network of an exemplary quantile regression soft actor-critic (QR-SAC) algorithm to inform the agent on reward weights, according to an illustrative embodiment, using a subset of non-fixed dimensions of scalar component weights, w, and parameters, θ, as w* and θ*;

FIG. 3 illustrates a graph showing changes in an agent's Q-value prior to an event occurring;

FIG. 4 illustrates a graph showing Q-values for different UVFA weights before an event;

FIG. 5 illustrates a graph showing a variance of Q-values before an event; and

FIG. 6 provides a functional block diagram illustration of a computer hardware platform that can be used to implement a particularly configured computing device that can host an AI agent.

Unless otherwise indicated, the figures are not necessarily drawn to scale.

The invention and its various embodiments can now be better understood by turning to the following detailed description wherein illustrated embodiments are described. It is to be expressly understood that the illustrated embodiments are set forth as examples and not by way of limitations on the invention as ultimately defined in the claims.

### DETAILED DESCRIPTION OF THE PREFERRED EMBODIMENTS AND BEST MODE OF INVENTION

The terminology used herein is for the purpose of describing particular embodiments only and is not intended to be limiting of the invention. As used herein, the term “and/or” includes any and all combinations of one or more of the associated listed items. As used herein, the singular forms “a,” “an,” and “the” are intended to include the plural forms as well as the singular forms, unless the context clearly indicates otherwise. It will be further understood that the terms “comprises” and/or “comprising,” when used in this specification, specify the presence of stated features, steps, operations, elements, and/or components, but do not preclude the presence or addition of one or more other features, steps, operations, elements, components, and/or groups thereof.

Unless otherwise defined, all terms (including technical and scientific terms) used herein have the same meaning as commonly understood by one having ordinary skill in the art to which this invention belongs. It will be further understood that terms, such as those defined in commonly used dictionaries, should be interpreted as having a meaning that is consistent with their meaning in the context of the relevant art and the present disclosure and will not be interpreted in an idealized or overly formal sense unless expressly so defined herein.

In describing the invention, it will be understood that a number of techniques and steps are disclosed. Each of these has individual benefit and each can also be used in conjunction with one or more, or in some cases all, of the other disclosed techniques. Accordingly, for the sake of clarity, this description will refrain from repeating every possible combination of the individual steps in an unnecessary fashion. Nevertheless, the specification and claims should be read with the understanding that such combinations are entirely within the scope of the invention and the claims.

In the following description, for purposes of explanation, numerous specific details are set forth in order to provide a thorough understanding of the present invention. It will be evident, however, to one skilled in the art that the present invention may be practiced without these specific details.

The present disclosure is to be considered as an exemplification of the invention and is not intended to limit the invention to the specific embodiments illustrated by the figures or description below.

A “computer” or “computing device” may refer to one or more apparatus and/or one or more systems that are capable of accepting a structured input, processing the structured input according to prescribed rules, and producing results of the processing as output. Examples of a computer or computing device may include: a computer; a stationary and/or portable computer; a computer having a single processor, multiple processors, or multi-core processors, which may operate in parallel and/or not in parallel; a supercomputer; a mainframe; a super mini-computer; a mini-computer; a workstation; a micro-computer; a server; a client; an interactive television; a web appliance; a telecommunications device with internet access; a hybrid combination of a computer and an interactive television; a portable computer; a tablet personal computer (PC); a personal digital assistant (PDA); a portable telephone; application-specific hardware to emulate a computer and/or software, such as, for example, a digital signal processor (DSP), a field programmable gate array (FPGA), an application specific integrated circuit (ASIC), an application specific instruction-set processor (ASIP), a chip, chips, a system on a chip, or a chip set; a data acquisition device; an optical computer; a quantum computer; a biological computer; and generally, an apparatus that may accept data, process data according to one or more stored software programs, generate results, and typically include input, output, storage, arithmetic, logic, and control units.

“Software” or “application” may refer to prescribed rules to operate a computer. Examples of software or applications may include code segments in one or more computer-readable languages; graphical and/or textual instructions; applets; pre-compiled code; interpreted code; compiled code; and computer programs.

These computer program instructions may also be stored in a computer readable medium that can direct a computer, other programmable data processing apparatus, or other devices to function in a particular manner, such that the instructions stored in the computer readable medium produce an article of manufacture including instructions which implement the function/act specified in the flowchart and/or block diagram block or blocks.

Further, although process steps, method steps, algorithms or the like may be described in a sequential order, such processes, methods and algorithms may be configured to work in alternate orders. In other words, any sequence or order of steps that may be described does not necessarily indicate a requirement that the steps be performed in that order. The steps of processes described herein may be performed in any order practical. Further, some steps may be performed simultaneously.

It will be readily apparent that the various methods and algorithms described herein may be implemented by, e.g., appropriately programmed computers and computing devices. Typically, a processor (e.g., a microprocessor) will receive instructions from a memory or like device, and execute those instructions, thereby performing a process defined by those instructions. Further, programs that implement such methods and algorithms may be stored and transmitted using a variety of known media.

The term “computer-readable medium” as used herein refers to any medium that participates in providing data (e.g., instructions) which may be read by a computer, a processor or a like device. Such a medium may take many forms, including but not limited to, non-volatile media, volatile media, and transmission media. Non-volatile media include, for example, optical or magnetic disks and other persistent memory. Volatile media include dynamic random access memory (DRAM), which typically constitutes the main memory. Transmission media include coaxial cables, copper wire and fiber optics, including the wires that comprise a system bus coupled to the processor. Transmission media may include or convey acoustic waves, light waves and electromagnetic emissions, such as those generated during radio frequency (RF) and infrared (IR) data communications. Common forms of computer-readable media include, for example, a floppy disk, a flexible disk, hard disk, magnetic tape, any other magnetic medium, a CD-ROM, DVD, any other optical medium, punch cards, paper tape, any other physical medium with patterns of holes, a RAM, a PROM, an EPROM, a FLASHEEPROM, any other memory chip or cartridge, a carrier wave as described hereinafter, or any other medium from which a computer can read.

Various forms of computer readable media may be involved in carrying sequences of instructions to a processor. For example, sequences of instruction (i) may be delivered from RAM to a processor, (ii) may be carried over a wireless transmission medium, and/or (iii) may be formatted according to numerous formats, standards or protocols, such as Bluetooth, TDMA, CDMA, 3G, 4G, 5G or the like.

Embodiments of the present invention may include apparatuses for performing the operations disclosed herein. An apparatus may be specially constructed for the desired purposes, or it may comprise a device selectively activated or reconfigured by a program stored in the device.

Unless specifically stated otherwise, and as may be apparent from the following description and claims, it should be appreciated that throughout the specification descriptions utilizing terms such as “processing,” “computing,” “calculating,” “determining,” or the like, refer to the action and/or processes of a computer or computing system, or similar electronic computing device, that manipulate and/or transform data represented as physical, such as electronic, quantities within the computing system's registers and/or memories into other data similarly represented as physical quantities within the computing system's memories, registers or other such information storage, transmission or display devices.

In a similar manner, the term “processor” may refer to any device or portion of a device that processes electronic data from registers and/or memory to transform that electronic data into other electronic data that may be stored in registers and/or memory or may be communicated to an external device so as to cause physical changes or actuation of the external device.

As used herein, the term “adaptively adjustable” refers to a value in a reinforcement learning model that may be adjustable while the agent is acting under the model. For example, an artificial intelligent agent may operate a race car in a car racing game. During training and/or during a race, the weights for various parameters can be adjusted in efforts to avoid a future negative event, such as a spin out, car collisions, driving off track, hitting the track barriers and the like. Such weights may later be changed back, by the agent, once the future negative event is avoided, all of which can occur during the race or training epoch.

As is well known to those skilled in the art, many careful considerations and compromises typically must be made when designing for the optimal configuration of a commercial implementation of any method or system, and in particular, the embodiments of the present invention. A commercial implementation in accordance with the spirit and teachings of the present invention may be configured according to the needs of the particular application, whereby any aspect(s), feature(s), function(s), result(s), component(s), approach(es), or step(s) of the teachings related to any described embodiment of the present invention may be suitably omitted, included, adapted, mixed and matched, or improved and/or optimized by those skilled in the art, using their average skills and known techniques, to achieve the desired implementation that addresses the needs of the particular application.

Broadly, embodiments of the present invention provide systems and methods to develop artificial intelligence (AI) policies for artificial agents for various domains, where the behavior of such AI agents can be changed during run time by the agent adaptively adjusting weights for select parameters. The agents can be trained across a number of weights within the desired range for each component. These weights determine how much of a reward portion for each component should be considered by the agent during training. Thus, a formulation can be realized for UVFA-like goals based on compositional reward functions parameterized by their components' weights. The agents may be configured to predict a future negative event, where the agent can adaptively adjust the components' weights, in runtime, in efforts to avoid the predicted future negative event.

As discussed in greater detail below, aspects of the present invention provide the ability to train an agent across a plurality of weights for various parameters of the domain, such as an open world game domain or an auto racing domain, where the weight becomes an input to the neural network, so that the weights and parameters can be adaptively adjusted during run time by the agent to avoid a predicted negative future event. In some embodiments, the weighting and parameters can be provided as an input to both the policy and the Q-function.

In some embodiments, the agent is trained in a training step so that the agent can recognize a predicted future negative event, such as a spin out in select weights and parameters during game play. In other embodiments, the agent may also be trained during game play as well, where the results from adjusting the adaptably adjustable weights and parameters for game play can be fed back into neural network to update the policy as needed. Other negative events that may be recognized and predicted can include driving off track, collisions between cars, spinning out of control, hitting the track barriers, and the like.

### Goal & Reward Representation

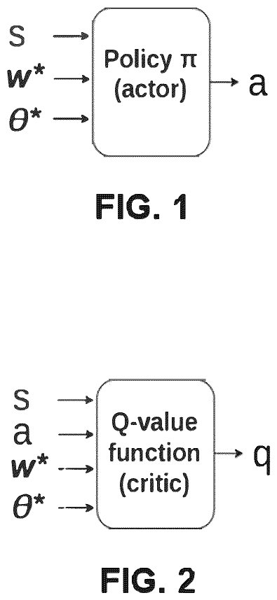

Referring to FIGS. 1 and 2, an environment's reward function R can be defined based on state s and action a as a linear combination of m components, as is done in many, if not most, Reinforcement Learning (RL) applications:

$$R ( s , a , w ) := {\sum }_{i = 1}^{m} {w}_{i} {R}_{i} ( s , a )$$

where wᵢ is a scalar component weight and Rᵢ(s, a) is the reward function for the i-th component with some specified weight parameters w. The rewards are a function of state, s and action, a, and sampled different weight values, w, can be multiplied by the reward.

Aspects of the present invention, however, can train an agent over a continuous goal space that includes parametrized reward functions represented by their weights and parameters. For example, the parameter θ is a variable used to represent the neural network weights for the policy and critic. Instead of keeping w and θ fixed, aspects of the present invention sample along multiple dimensions i of w and, optionally, θ, from either a continuous or discrete distribution. This subset of non-fixed dimensions of w and, optionally, θ, is denoted as w* and θ* respectively. It should be noted that, for sampling, any distribution can be used, including, but not limited to, uniform and skewed distributions, discrete and affine sets. Sampling can occur once per training rollout at the beginning of the episode (i.e., staying fixed thereafter), or after a fixed amount of episode steps. To inform the trained agent of the reward function it is operating under, aspects of the present invention provide both w* and θ* as additional input to both the policy (actor) and value functions (critic) of the training algorithm, as illustrated in FIGS. 1 and 2.

More specifically, aspects of the present invention expand the policy π(s) and action-value function Q(s, a) by alternatively (1) directly concatenating the reward component weights and parameters with the rest of the inputs, thus obtaining a policy π(s, w*, θ*) and an action-value function Q(s, a, w*, θ*); or (2) inputting the reward component weights and parameters to a representation function (typically a neural network), possibly shared between actor and critic, that generates a compressed representation of the goal space, and then concatenating such representation with the rest of the inputs. In this case a policy π(s, φ(w*, θ*)) and an action-value function Q(s, a, φ′(w*, θ*)) are obtained, where φ and φ′ could possibly coincide.

With additional parameters w* and ω* on both the policy and action-value function, the training loss changes as well. More in detail, the critic training loss now becomes a function of both the state-action pairs (s, a) and the new parameters, and can be mathematically represented as L_{critic} (s, a, w*, θ*). The addition of w* and ω* to the critic loss function influences the learning process by adjusting how the critic parameters (such as, the neural network weights) are updated during training to better estimate the value function. Similarly, their incorporation into the actor loss L_{actor} (s, w*, θ*) function influences the training dynamics, affecting how the actor parameters are updated during optimization to enhance action selection. Intuitively, the actor will learn to not only map states to actions, but also reward parameters and component weights. As a result, changing them will result in the choice of different actions.

### Agent Behavior Controllability

Controllability during runtime in reinforcement learning refers to the ability to influence the behavior of an agent while it is interacting with the environment and making decisions. Unlike traditional control systems, where actions are directly dictated by external commands, RL agents make decisions based on learned policies, often making controllability more nuanced.

Here, aspects of the present invention propose a solution that exploits the previously described representation. Specifically, when evaluating the agent's policy at inference time, w* and θ* can be set to any of the weights and parameters covered during training, and thanks to neural network generalization, also to unseen ones. According to the specified values, the agent will adapt its behavior and strive to behave optimally under the represented reward function without any retraining. Further, during runtime, the weights and parameters can be adaptively adjusted so that the agent behavior can be controlled, i.e., its behavior can be changed by simply mutating w* and θ*. As discussed below, the agent can be trained to predict a negative event, such as a spin out, driving off track, collisions between cars, hitting a track barrier, or the like, in a auto race game, and adaptively adjust the weights of certain parameters to avoid realizing the predicted negative event.

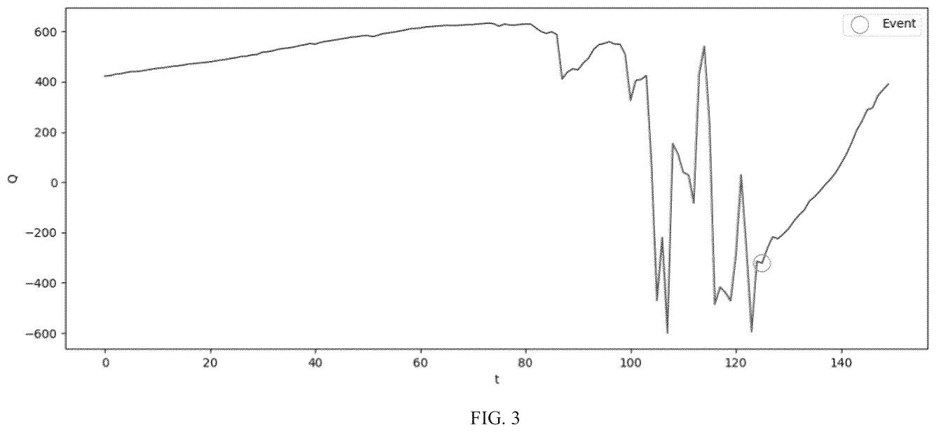

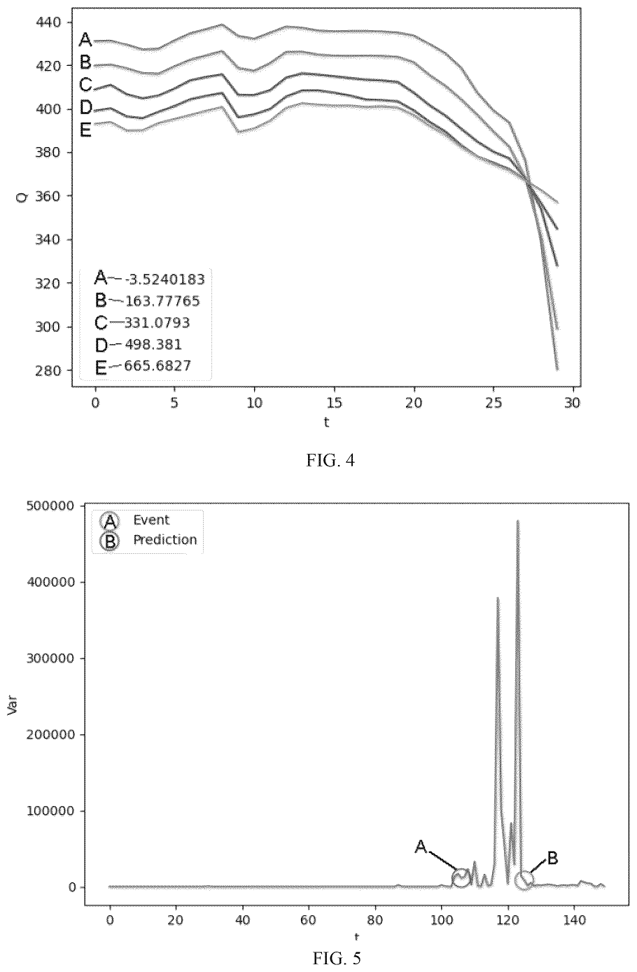

Referring to FIG. 3, the artificial agent can be configured to know when an adverse or negative event is about to occur. For example, as shown in FIG. 3, by monitoring Q values, about 2 to 3 seconds before the negative event, such as a spin out, car collisions, driving off the track, hitting the track barriers, or the like, in a racing game, the Q value can suddenly drop, indicating to the agent that such an event may be about to occur. The agent may learn what event is about to happen based on the Q value variations through training and observations when such events do occur. As discussed above, the agent can adaptively adjust weights of certain parameters to try to avoid the occurrence of such a negative event based on the observations, such as the observations shown in FIG. 3, prior to the event occurring. The agent may then reset the weights after avoidance of the adverse event. In some embodiments, the agent may learn how adjusting the weights and which parameters to adjust with these adjusted weights based on results from training episodes. The Q-value in FIG. 3 may be minimum of the two critics' mean of the quantiles in quantile regression soft actor-critic (QR-SAC).

Referring to FIG. 4, it can be seen how different UVFA weights have different opinions on the future. Embodiments of the present invention can use the UVFA weights as an ensemble of models. Because their reward will be different based on the event, their estimate of the expected cumulative reward will be different and their actions (in the same state) will be different. Weights can be chosen for certain parameters that will provide a minimum norm of the derivative of the Q value in time (finite time difference) with respect to the previous time step. In other words, weight that provides the most stable Q value over time can be selected when an adverse event is detected in efforts to avoid such an event. While five weights are shown, it should be understood that a plurality of weights can be used, where, when more variance is found, more weights may be helpful in finding the optimal weights to try to avoid the event from occurring.

FIG. 5 shows how the variance in the Q value can increase prior to an event, such as a negative or adverse event. Given this variance at a time step, an event can be predicted based on (1) a normalized derivative of the Q value being above a given threshold, (2) a normalized variance above a given threshold, and/or (3) a derivative of the variance having a local maxima, where its first derivative is zero and its second derivate is negative. Typically, if two of these hyperparameters are found, the agent can predict a upcoming adverse event. As discussed above, once detected, the agent can determine weights to adjust in order to try to “smooth” the Q-value and its variance, and avoid the occurrence of the adverse event.

While the above disclosure focuses on the domain of a racing game, it should be understood that aspects of the present invention may be applied to AI agents used in various different domains. For example, the AI agent may be one in an animation or locomotion domain, where, for example, one of the components may be provided to change the weight of an energy cost to create slower, faster or more expressive walking of the AI agent.

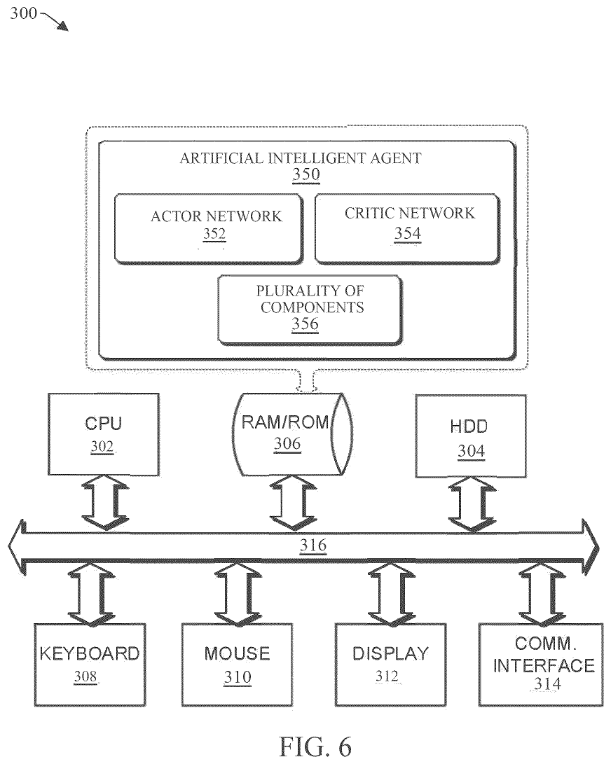

FIG. 6 provides a functional block diagram illustration of a computer hardware platform 300 that can be used to implement a particularly configured computing device that can host an AI agent 350. The AI agent 350, as discussed above, can include an actor network 352, a critic network 354 and a plurality of components 356 that can be each separately weighted for training and operating the AI agent.

The computer platform 300 may include a central processing unit (CPU) 302, a hard disk drive (HDD) 304, random access memory (RAM) and/or read only memory (ROM) 306, a keyboard 308, a mouse 310, a display 312, and a communication interface 314, which are connected to a system bus 316.

In one embodiment, the HDD 304, has capabilities that include storing a program that can execute various processes, such as the operation of the AI agent 350, in a manner to perform the methods described herein.

All the features disclosed in this specification, including any accompanying abstract and drawings, may be replaced by alternative features serving the same, equivalent or similar purpose, unless expressly stated otherwise. Thus, unless expressly stated otherwise, each feature disclosed is one example only of a generic series of equivalent or similar features.

Claim elements and steps herein may have been numbered and/or lettered solely as an aid in readability and understanding. Any such numbering and lettering in itself is not intended to and should not be taken to indicate the ordering of elements and/or steps in the claims.

Many alterations and modifications may be made by those having ordinary skill in the art without departing from the spirit and scope of the invention. Therefore, it must be understood that the illustrated embodiments have been set forth only for the purposes of examples and that they should not be taken as limiting the invention as defined by the following claims. For example, notwithstanding the fact that the elements of a claim are set forth below in a certain combination, it must be expressly understood that the invention includes other combinations of fewer, more or different ones of the disclosed elements.

The words used in this specification to describe the invention and its various embodiments are to be understood not only in the sense of their commonly defined meanings, but to include by special definition in this specification the generic structure, material or acts of which they represent a single species.

The definitions of the words or elements of the following claims are, therefore, defined in this specification to not only include the combination of elements which are literally set forth. In this sense it is therefore contemplated that an equivalent substitution of two or more elements may be made for any one of the elements in the claims below or that a single element may be substituted for two or more elements in a claim. Although elements may be described above as acting in certain combinations and even initially claimed as such, it is to be expressly understood that one or more elements from a claimed combination can in some cases be excised from the combination and that the claimed combination may be directed to a subcombination or variation of a subcombination.

Insubstantial changes from the claimed subject matter as viewed by a person with ordinary skill in the art, now known or later devised, are expressly contemplated as being equivalently within the scope of the claims. Therefore, obvious substitutions now or later known to one with ordinary skill in the art are defined to be within the scope of the defined elements.

The claims are thus to be understood to include what is specifically illustrated and described above, what is conceptually equivalent, what can be obviously substituted and also what incorporates the essential idea of the invention.

What is claimed is:

1. A method for operating an artificial intelligent agent based on a weighted composition of parametric reward functions, the method comprising:
defining a reward function based on a state and an action as a linear combination of a plurality of parameterized reward functions and a weight for each parameter of the plurality of parameterized reward functions;
sampling multiple dimensions of the weight and the parameter for each of the plurality of parameterized reward functions from either a continuous or a discrete distribution;
training a single policy of the artificial intelligent agent over a continuous goal space including the plurality of parameterized reward functions represented by the continuous distribution of the weight and the parameter for each of the plurality of parameterized reward functions; and
adaptively adjusting, during operation of the artificial intelligent agent, the weight for one or more selected parameters of the parameterized reward functions.

2. The method of claim 1, further comprising predicting an occurrence of an event based on a Q-value determination during operation of the artificial intelligent agent.

3. The method of claim 2, wherein the occurrence of the event is avoided by the adaptively adjusting of the weight.

4. The method of claim 2, wherein the predicted occurrence is determined by detecting one or more of the following indicators: (1) a normalized derivative of a Q value being above a given threshold, (2) a normalized variance of the Q value above a given threshold, and (3) a derivative of the normalized variance having a local maxima.

5. The method of claim 4, wherein a determination of two of the indicators prompts the artificial intelligent to adaptively adjust one or more weight to avoid occurrence of the predicted event.

6. The method of claim 5, wherein the adaptively adjusted one or more weight is selected that provides a minimum norm of the derivative of the Q value in time thereof.

7. The method of claim 1, further comprising improving a performance of the artificial intelligent agent over a segment of the continuous distribution of the weight by providing a skewed distribution of weight, wherein the training is performed over the skewed distribution of weight for one or more of the plurality of component reward functions.

8. The method of claim 7, wherein the skewed distribution of weight is a log-uniform distribution.

9. The method of claim 1, further comprising applying the continuous distribution of weights and parameters to both a policy and a value function of a soft actor critic model.

10. The method of claim 9, further comprising updating a neural network policy from π(s) to w(s, w*, θ*) and the action-value function Q(s, a) to Q(s, a, w*, θ*) by conditioning on a continuous distribution of weights, w* and parameters θ* along with state, s, and action, a.

11. The method of claim 1, further comprising evaluating the single policy of the artificial intelligent agent at inference time by choosing a chosen weight and a chosen parameter for each of the plurality of parameterized reward functions, wherein the artificial intelligent agent behaves accordingly under a chosen reward function without any retraining.

12. The method of claim 1, wherein the artificial intelligent agent operates in a racing game environment.

13. The method of claim 12, wherein the event is an adverse event in the racing game environment.

14. The method of claim 1, wherein each of the plurality of parameterized reward functions are defined within the single policy of the artificial intelligent agent.

15. A method for avoiding an adverse event by an artificial intelligent agent operating in a racing game, the method comprising:
defining a reward function based on a state and an action as a linear combination of a plurality of parameterized reward functions and a weight for each parameter of the plurality of parameterized reward functions;
sampling multiple dimensions of the weight and the parameter for each of the plurality of parameterized reward functions from either a continuous or a discrete distribution;
training a single policy of the artificial intelligent agent over a continuous goal space including the plurality of parameterized reward functions represented by the continuous distribution of the weight and the parameter for each of the plurality of parameterized reward functions;
predicting an occurrence of the adverse event based on a Q-value determination during operation of the artificial intelligent agent; and
adaptively adjusting, during operation of the artificial intelligent agent, the weight for one or more selected parameters of the parameterized reward functions to avoid the occurrence of the adverse event.

16. The method of claim 15, wherein the predicted occurrence is determined by detecting one or more of the following indicators: (1) a normalized derivative of a Q value being above a given threshold, (2) a normalized variance of the Q value above a given threshold, and (3) a derivative of the normalized variance having a local maxima.

17. The method of claim 16, wherein a determination of two of the indicators prompts the artificial intelligent to adaptively adjust one or more weight to avoid occurrence of the predicted event.

18. The method of claim 15, wherein the adaptively adjusted one or more weight is selected that provides a minimum norm of the derivative of the Q value in time thereof.

19. A non-transitory computer readable storage medium tangibly embodying a computer readable program code having computer readable instructions that, when executed, causes a computer device to carry out a method of operating an artificial intelligent agent that generalizes over continuous behaviors in multiple dimensions, the method comprising:
defining a reward function based on a state and an action as a linear combination of a plurality of parameterized reward functions and a weight for each parameter of the plurality of parameterized reward functions;
sampling multiple dimensions of the weight and the parameter for each of the plurality of parameterized reward functions from either a continuous or a discrete distribution;
training a single policy of the artificial intelligent agent over a continuous goal space including the plurality of parameterized reward functions represented by the continuous distribution of the weight and the parameter for each of the plurality of parameterized reward functions;
predicting an occurrence of an event based on a Q-value determination during operation of the artificial intelligent agent;
adaptively adjusting, during operation of the artificial intelligent agent, the weight for one or more selected parameters of the parameterized reward functions to avoid the occurrence of the event.

20. The method of claim 19, wherein the predicted occurrence is determined by detecting one or more of the following indicators: (1) a normalized derivative of a Q value being above a given threshold, (2) a normalized variance of the Q value above a given threshold, and (3) a derivative of the normalized variance having a local maxima.
